(19) United States
(12) Patent Application Publication
(10) Pub. No.: US 2021/0192239 A1
(43) Pub. Date: Jun. 24, 2021

(54) METHOD FOR RECOGNIZING INDICATION INFORMATION OF AN INDICATOR LIGHT, ELECTRONIC APPARATUS AND STORAGE MEDIUM

(71) Applicant: SENSETIME GROUP LIMITED, Hong Kong (CN)

(72) Inventors: Jiabin MA, Hong Kong (CN); Zheqi HE, Hong Kong (CN); Kun WANG, Hong Kong (CN); Xingyu ZENG, Hong Kong (CN)

(73) Assignee: SENSETIME GROUP LIMITED, Hong Kong (CN)

(21) Appl. No.: 17/194,175

(22) Filed: Mar. 5, 2021

Related U.S. Application Data
(63) Continuation of application No. PCT/CN2020/095437, filed on Jun. 10, 2020.

(30) Foreign Application Priority Data
Jun. 27, 2019 (CN) 201910569896.8

(51) Int. Cl. G06K 9/00; G06K 9/62; G06K 9/46; G08G 1/0967

(52) U.S. Cl. CPC G06K 9/00825; G06K 9/6227; G06K 2209/21; G08G 1/096725; G06K 9/4652

(57) ABSTRACT

The present disclosure relates to a method and device for recognizing indication information of indicator lights, an electronic apparatus, and a storage medium. The method comprises: acquiring an input image; determining a detection result of a target object based on the input image, the target object including at least one of an indicator light base and an indicator light in a lighted state, and the detection result including a type of the target object and a position of the target region where the target object in the input image is located; and recognizing, based on the detection result of the target object, the target region where the target object in the input image is located to obtain indication information of the target object.

### CROSS-REFERENCE TO RELATED APPLICATIONS

The present disclosure is a continuation of and claims priority under 35 U.S.C. § 120 to PCT Application. No. PCT/CN2020/095437, filed on Jun. 10, 2020, which claims priority to Chinese Patent Application No. 201910569896.8, filed with National Intellectual Property Administration, PRC, on Jun. 27, 2019, entitled “METHOD AND DEVICE FOR RECOGNIZING INDICATION INFORMATION OF AN INDICATOR LIGHT, ELECTRONIC APPARATUS AND STORAGE MEDIUM”. All the above referenced priority documents are incorporated herein by reference in their entireties.

### TECHNICAL FIELD

The present disclosure relates to the technical field of computer vision, and in particular, to a method and device for recognizing indication information of indicator lights, an electronic apparatus and a storage medium.

### BACKGROUND

Traffic lights are devices mounted on roads to provide guidance signals for vehicles and pedestrians. Road conditions are very complicated, and emergencies or accidents may occur at any time. The traffic lights can regulate passing time of different objects to resolve many conflicts and prevent occurrence of accidents. For example, at an intersection, vehicles in different lanes may preempt to pass the intersection, thereby causing conflicts.

In practice, traffic lights may be applied in different scenarios and have different shapes and types, and exhibit a complex association relationship therein.

### SUMMARY

The present disclosure proposes a technical solution for recognizing indication information of indicator lights.

According to one aspect of the present disclosure, there is provided a method for recognizing indication information of indicator lights, comprising:

acquiring an input image;

determining a detection result of a target object based on the input image, the target object including at least one of an indicator light base and an indicator light in a lighted state, and the detection result including a type of the target object and a position of the target region where the target object in the input image is located; and

recognizing, based on the detection result of the target object, the target region where the target object in the input image is located, to obtain indication information of the target object.

In some possible implementations, determining a detection result of a target object based on the input image comprises:

extracting an image feature of the input image;

determining, based on the image feature of the input image, a first position of each candidate region in at least one candidate region of the target object;

determining an intermediate detection result of each candidate region based on an image feature at a first position corresponding to each candidate region in the input image, the intermediate detection result including a predicted type of the target object and the prediction probability that the target object is the predicted type; the predicted type being any one of an indicator light base and N types of indicator lights in a lighted state, N being a positive integer;

and

determining a detection result of the target object based on the intermediate detection result of each candidate region in at least one candidate region and the first position of each candidate region.

In some possible implementations, determining an intermediate detection result of each candidate region based on an image feature at a first position corresponding to each candidate region in the input image comprises:

classifying, for each candidate region, the target object in the candidate region based on the image feature at the first position corresponding to the candidate region, to obtain the prediction probability that the target object is each of at least one preset type, wherein the preset type includes at least one of an indicator light base and N types of indicator lights in a lighted state, N being a positive integer; and

taking the preset type with the highest prediction probability in the at least one preset type as the predicted type of the target object in the candidate region, and obtaining a prediction probability of the predicted type.

In some possible implementations, before determining a detection result of the target object based on the intermediate detection result of each candidate region in at least one candidate region and the first position of each candidate region, the method further comprises:

determining a position deviation of a first position of each candidate region based on the image feature of the input image; and

adjusting the first position of each candidate region according to the position deviation corresponding to each candidate region.

In some possible implementations, determining a detection result of the target object based on the intermediate detection result of each candidate region in at least one candidate region and the first position of each candidate region comprises:

filtering, in response to the case where there are at least two candidate regions of the target object, a target region from the at least two candidate regions based on the intermediate detection result of each candidate region of the at least two candidate regions, or based on the intermediate detection result of each candidate region and the first position of each candidate region; and

taking the predicted type of the target object in the target region as the type of the target object, taking the first position of the target region as the position of the target region where the target object is located, to obtain a detection result of the target object.

In some possible implementations, after determining a detection result of a target object based on the input image, the method further comprises at least one of:

determining, in response to the case where the detection result of the target object includes only a detection result corresponding to an indicator light base, that the indicator light is in a fault state; and

determining, in response to the case where the detection result of the target object includes only a detection result corresponding to an indicator light in a lighted state, that the scenario state in which the input image is captured is a dark state.

In some possible implementations, recognizing, based on the detection result of the target object, the target region where the target object in the input image is located to obtain indication information of the target object comprises:

determining a classifier matching the target object based on the type of the target object in the detection result of the target object; and

recognizing, by means of a matching classifier, an image feature of the target region in the input image to obtain indication information of the target object.

In some possible implementations, recognizing, based on the detection result of the target object, the target region where the target object in the input image is located, to obtain indication information of the target object comprises:

determining, in response to the case where the type of the target object is an indicator light base, that the matching classifier includes a first classifier configured to recognize an arrangement mode of indicator lights in the indicator light base; and recognizing, by means of the first classifier, an image feature of the target region where the target object is located, to determine the arrangement mode of indicator lights in the indicator light base; and/or

determining that the matching classifier includes a second classifier configured to recognize a scenario where the indicator lights are located; and recognizing, by means of the second classifier, an image feature of the target region where the target object is located, to determine information about the scenario where the indicator lights are located.

In some possible implementations, recognizing, based on the detection result of the target object, the target region where the target object in the input image is located, to obtain indication information of the target object comprises:

determining, in response to the case where the type of the target object is a circular spot light or a pedestrian light, that the matching classifier includes a third classifier configured to recognize a color attribute of the circular spot light or the pedestrian light; and

recognizing, by means of the third classifier, an image feature of the target region where the target object is located, to determine the color attribute of the circular spot light or the pedestrian light.

In some possible implementations, recognizing, based on the detection result of the target object, the target region where the target object in the input image is located, to obtain indication information of the target object comprises:

determining, in response to the case where the type of the target object is an arrow light, that the matching classifier includes a fourth classifier configured to recognize a color attribute of the arrow light, and a fifth classifier configured to recognize a direction attribute of the arrow light; and

recognizing, by means of the fourth classifier and the fifth classifier, an image feature of the target region where the target object is located, to determine the color attribute and the direction attribute of the arrow light, respectively.

In some possible implementations, recognizing, based on the detection result of the target object, the target region where the target object in the input image is located, to obtain indication information of the target object comprises:

determining, in response to the case where the type of the target object is a digit light, that the matching classifier includes a sixth classifier configured to recognize a color attribute of the digit light, and a seventh classifier configured to recognize a numerical attribute of the digit light; and

recognizing, by means of the sixth classifier and the seventh classifier, an image feature of the target region where the target object is located, to determine the color attribute and the numerical attribute of the digit light, respectively.

In some possible implementations, in response to the case where the input image includes at least two indicator light bases, the method further comprises:

determining, for a first indicator light base, an indicator light in a lighted state matching the first indicator light base; the first indicator light base being one of the at least two indicator light bases; and

combining indication information of the first indicator light base and indication information of the indicator light in a lighted state matching the first indicator light base to obtain combined indication information.

In some possible implementations, determining an indicator light in a lighted state matching the first indicator light base comprises:

determining, based on the position of the target region where the target object is located in the detection result of the target object, a first area of an intersection between the target region where the at least one indicator light in a lighted state is located and the target region where the first indicator light base is located, and a second area of the target region where the at least one indicator light in a lighted state is located; and

determining, in response to the case where a ratio between the first area between a first indicator light in a lighted state and the first indicator light base, and the second area of the first indicator light in a lighted state is greater than a given area threshold, that the first indicator light in a lighted state matches the first indicator light base;

wherein the first indicator light in a lighted state is one of the at least one indicator light in a lighted state.

According to a second aspect of the present disclosure, there is provided a driving control method, comprising:

capturing a driving image by an image capturing apparatus in an intelligent driving apparatus;

executing the method for recognizing indication information of indicator lights according to the first aspect on the driving image to obtain indication information of the driving image; and

generating a control instruction for the intelligent driving apparatus based on the indication information.

According to a third aspect of the present disclosure, there is provided a device for recognizing indication information of indicator lights, comprising:

an acquiring module configured to acquire an input image;

a determining module configured to determine a detection result of a target object based on the input image, the target object including at least one of an indicator light base and an indicator light in a lighted state, and the detection result including a type of the target object and a position of the target region where the target object in the input image is located; and

a recognizing module configured to recognize, based on the detection result of the target object, the target region where the target object in the input image is located, to obtain indication information of the target object.

In some possible implementations, the determining module is further configured to:

extract an image feature of the input image;

determine, based on the image feature of the input image, a first position of each candidate region in at least one candidate region of the target object;

determine an intermediate detection result of each candidate region based on an image feature at a first position corresponding to each candidate region in the input image, the intermediate detection result including a predicted type of the target object and the prediction probability that the target object is the predicted type; the predicted type being any one of an indicator light base and N types of indicator lights in a lighted state, N being a positive integer;

and

determine a detection result of the target object based on the intermediate detection result of each candidate region in at least one candidate region and the first position of each candidate region.

In some possible implementations, the determining module is further configured to: classify, for each candidate region, the target object in the candidate region based on the image feature at the first position corresponding to the candidate region, and obtain the prediction probability that the target object is each of at least one preset type, wherein the preset type includes at least one of an indicator light base and N types of indicator lights in a lighted state, N being a positive integer; and

take the preset type with the highest prediction probability in the at least one preset type as the predicted type of the target object in the candidate region, and obtain a prediction probability of the predicted type.

In some possible implementations, the determining module is further configured to: before determining a detection result of the target object based on the intermediate detection result of each candidate region in at least one candidate region and the first position of each candidate region, determine a position deviation of a first position of each candidate region based on the image feature of the input image; and

adjust the first position of each candidate region by the position deviation corresponding to each candidate region.

In some possible implementations, the determining module further configured to filter, in the case where there are at least two candidate regions of the target object, a target region from the at least two candidate regions based on the intermediate detection result of each of the at least two candidate regions, or based on the intermediate detection result of each candidate region and the first position of each candidate region; and

take the predicted type of the target object in the target region as the type of the target object, and take the first position of the target region as the position of the target region where the target object is located, to obtain a detection result of the target object.

In some possible implementations, the determining module is further configured to determine, in the case where the detection result of the target object includes only a detection result corresponding to an indicator light base, that the indicator light is in a fault state; and

determine, in the case where the detection result of the target object includes only a detection result of an indicator light in a lighted state, that the scenario state in which the input image is captured is a dark state.

In some possible implementations, the recognizing module is further configured to determine a classifier matching the target object based on the type of the target object in the detection result of the target object; and

recognize, by means of a matching classifier, an image feature of the target region in the input image to obtain indication information of the target object.

In some possible implementations, the recognizing module is further configured to determine, in response to the case where the type of the target object is an indicator light base, that the matching classifier includes a first classifier configured to recognize an arrangement mode of indicator lights in the indicator light base; and recognize, by means of the first classifier, an image feature of the target region where the target object is located, to determine the arrangement mode of indicator lights in the indicator light base; and/or

determine that the matching classifier includes a second classifier configured to recognize a scenario where the indicator lights are located; and recognize, by means of the second classifier, an image feature of the target region where the target object is located, to determine information about the scenario where the indicator lights are located.

In some possible implementations, the recognizing module is further configured to determine, in response to the case where the type of the target object is a circular spot light or a pedestrian light, that the matching classifier includes a third classifier configured to recognize a color attribute of the circular spot light or the pedestrian light; and

recognize, by means of the third classifier, an image feature of the target region where the target object is located, to determine the color attribute of the circular spot light or the pedestrian light.

In some possible implementations, the recognizing module is further configured to determine, in response to the case where the type of the target object is an arrow light, that the matching classifier includes a fourth classifier configured to recognize a color attribute of the arrow light, and a fifth classifier configured to recognize a direction attribute of the arrow light;

and

recognize, by means of the fourth classifier and the fifth classifier, an image feature of the target region where the target object is located, to determine the color attribute and the direction attribute of the arrow light, respectively.

In some possible implementations, the recognizing module is further configured to determine, in response to the case where the type of the target object is a digit light, that the matching classifier includes a sixth classifier configured to recognize a color attribute of the digit light, and a seventh classifier configured to recognize a numerical attribute of the digit light; and

recognize, by means of the sixth classifier and the seventh classifier, an image feature of the target region where the target object is located, to determine the color attribute and the numerical attribute of the digit light, respectively.

In some possible implementations, the device further comprises a matching module configured to determine, for a first indicator light base, an indicator light in a lighted state matching the first indicator light base in the case where the input image includes at least two indicator light bases; the first indicator light base being one of the at least two indicator light bases; and

combine indication information of the first indicator light base and indication information of the indicator light in a lighted state matching the first indicator light base to obtain combined indication information.

In some possible implementations, the matching module is further configured to:

determine, based on the position of the target region where the target object is located in the detection result of the target object, a first area of an intersection between the target region where the at least one indicator light in a lighted state is located and the target region where the first indicator light base is located, and a second area of the target region where the at least one indicator light in a lighted state is located; and

determine, in the case where a ratio between the first area between a first indicator light in a lighted state and the first indicator light base, and the second area of the first indicator light in a lighted state is greater than a given area threshold, that the first indicator light in a lighted state matches the first indicator light base;

wherein the first indicator light in a lighted state is one of the at least one indicator light in a lighted state.

According to a fourth aspect of the present disclosure, there is provided a driving control device, comprising:

an image capturing module disposed in an intelligent driving apparatus and configured to capture a driving image of the intelligent driving apparatus;

an image processing module configured to execute the method for recognizing indication information of indicator lights according to any one of the first aspect on the driving image to obtain indication information of the driving image; and

a control module configured to generate a control instruction for the intelligent driving apparatus based on the indication information.

According to a fifth aspect of the present disclosure, there is provided an electronic apparatus, comprising:

a processor; and

a memory configured to store processor-executable instructions;

wherein the processor is configured to invoke instructions stored in the memory to execute the method according to any one of the first or second aspect.

According to a sixth aspect of the present disclosure, there is provided a computer readable storage medium having computer program instructions stored thereon, wherein the computer program instructions, when executed by a processor, implement the method according to any one of the first or second aspect.

According to a seventh aspect of the present disclosure, there is provided a computer program, comprising a computer readable code, wherein when the computer readable code operates in an electronic apparatus, a processor of the electronic apparatus executes instructions for implementing the method according to any one of the first or second aspect.

In the embodiments of the present disclosure, it is possible to firstly perform target detection processing on an input image to obtain a detection result of a target object, wherein the detection result of the target object may include information such as the position and type of the target object, and then execute recognition of indication information of the target object based on the detection result of the target object. By dividing the detection process for the target object into two steps of detecting an indicator light base and an indicator light in a lighted state, the present disclosure achieves for the first time the distinction of the target object during the detection, which, during further recognition based on the detection result of the target object, is conducive to reducing the recognizing complexity in the process of recognizing indication information of the target object and reducing the difficulty in recognition, enabling it possible to simply and conveniently realize the detection and recognition of various types of indicator lights in different situations.

It should be understandable that the general description above and the following detailed description are merely exemplary and explanatory, and are not intended to limit the present disclosure.

Additional features and aspects of the present disclosure will become apparent from the following detailed description of exemplary embodiments with reference to the attached drawings.

### BRIEF DESCRIPTION OF THE DRAWINGS

The drawings herein, which are incorporated in and constitute part of the specification, illustrate embodiments in line with the present disclosure and serve, together with the description, to explain the technical solutions of the present disclosure.

FIG. 1 shows a flow chart of a method for recognizing indication information of indicator lights according to an embodiment of the present disclosure.

FIG. 2(a) shows different display states of traffic lights.

FIG. 2(b) shows different arrangement modes of traffic light bases.

FIG. 2(c) shows different application scenarios of traffic lights.

FIG. 2(d) shows a plurality of types of traffic lights.

FIG. 2(e) shows a schematic diagram of combinations of traffic lights in different situations.

FIG. 3 shows a flow chart of Step S20 in the method for recognizing indication information of indicator lights according to an embodiment of the present disclosure.

FIG. 4 shows a schematic diagram of executing target detection via a region proposal network according to an embodiment of the present disclosure.

FIG. 5 shows a flow chart of Step S30 in the method for recognizing indication information of indicator lights according to an embodiment of the present disclosure.

FIG. 6 shows a schematic diagram of classification detection of different target objects according to an embodiment of the present disclosure.

FIG. 7 shows a schematic diagram of the structure of traffic lights in a plurality of bases.

FIG. 8 shows another flow chart of a method for recognizing indication information of indicator lights according to an embodiment of the present disclosure.

FIG. 9 shows a flow chart of a driving control method according to an embodiment of the present disclosure.

FIG. 10 shows a block diagram of a device for recognizing indication information of indicator lights according to an embodiment of the present disclosure.

FIG. 11 shows a block diagram of a driving control device according to an embodiment of the present disclosure.

FIG. 12 shows a block diagram of an electronic apparatus according to an embodiment of the present disclosure.

FIG. 13 shows another block diagram of an electronic apparatus according to an embodiment of the present disclosure.

### DETAILED DESCRIPTION

Various exemplary examples, features and aspects of the present disclosure will be described in detail with reference to the drawings. The same reference numerals in the drawings represent parts having the same or similar functions. Although various aspects of the embodiments are shown in the drawings, it is unnecessary to proportionally draw the drawings unless otherwise specified.

Herein the specific term “exemplary” means “used as an instance or embodiment, or explanatory”. An “exemplary” embodiment given here is not necessarily construed as being superior to or better than other embodiments.

The term “and/or” used herein represents only an association relationship for describing associated objects, and represents three possible relationships. For example, A and/or B may represent the following three cases: A exists alone, both A and B exist, and B exists alone. In addition, the term “at least one” used herein indicates any one of multiple listed items or any combination of at least two of multiple listed items. For example, including at least one of A, B, and C may indicate including any one or more elements selected from the group consisting of A, B, and C.

Besides, numerous details are given in the following specific embodiments for the sake of better explaining the present disclosure. It should be understood by a person skilled in the art that the present disclosure can still be realized even without some of those details. In some of the examples, methods, means, units and circuits that are well known to a person skilled in the art are not described in detail so that the spirit of the present disclosure becomes apparent.

The method for recognizing indication information of indicator lights provided in the embodiments of the present disclosure may be used to execute detection of indication information of indicator lights of various types, wherein this method for recognizing indication information of indicator lights may be executed by an arbitrary electronic apparatus having an image processing function, for example, executed by terminal apparatus or servers or other processing apparatuses, in which the terminal apparatus may be User Equipment (UE), mobile apparatus, user terminals, terminals, cellular phones, cordless phones, Personal Digital Assistant (PDA), handheld apparatus, computing apparatus, vehicle-mounted apparatus, wearable apparatus, etc. Alternatively, in some possible implementations, the method for recognizing indication information of indicator lights may also be applied to intelligent driving apparatus, such as intelligent flight apparatus, intelligent vehicles, and blind guiding apparatus, for intelligent control of the intelligent driving apparatus. In addition, in some possible implementations, this method for recognizing indication information of indicator lights may be implemented by means of invoking, by a processor, computer readable instructions stored in the memory. The method for recognizing indication information of indicator lights provided in the embodiments of the present disclosure may be applied to scenarios such as recognition and detection of indication information of indicator lights, for instance, used for recognition for indication information of indicator lights in application scenarios such as automatic driving and monitoring. The present disclosure does not limit the specific application scenarios.

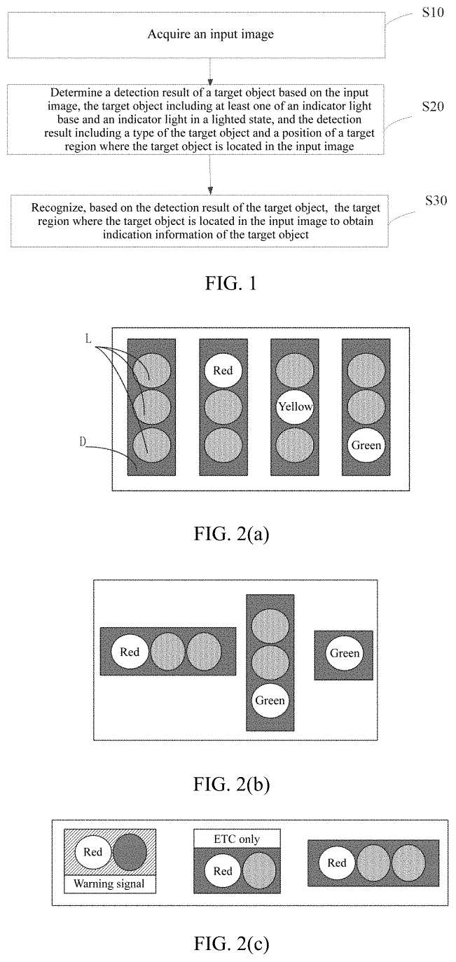

FIG. 1 shows a flow chart of a method for recognizing indication information of indicator lights according to an embodiment of the present disclosure. As shown in FIG. 1, the method for recognizing indication information of indicator lights, comprising:

S10: acquiring an input image.

In some possible implementations, an input image may be an image concerning indicator lights that may include at least one of traffic indicator lights (e.g., traffic lights), emergency indicator lights (e.g., a flashing indicator light), and direction indicator lights, and may also be other types of indicator lights in other embodiments.

The present disclosure can realize recognition of indication information of indicator lights in an input image. The input image may be an image captured by an image capturing apparatus, for example, a road driving image captured by an image capturing apparatus disposed in a vehicle, or an image captured by a laid camera, or in other embodiments, the input image may be an image captured by a handheld terminal apparatus or other apparatuses, or the input image may be an image frame selected from acquired video streaming, which is not specifically limited in the present disclosure.

S20: determining a detection result of a target object based on the input image, the target object including at least one of an indicator light base and an indicator light in a lighted state, and the detection result including a type of the target object and a position of the target region where the target object in the input image is located.

In some possible implementations, under the circumstance that an input image is obtained, a target object in the input image may be detected and recognized to obtain a detection result of the target object. The detection result may include the type and position information of the target object. In the embodiments of the present disclosure, it is possible to realize target detection of the target object in the input image via a neural network to obtain the detection result. This neural network enables it possible to realize detection of at least one of a type of an indicator light base, a type of an indicator light in a lighted state, a position of a base, and a position of a lighted indicator light in the input image. The detection result of the input image may be obtained by an arbitrary neural network capable of realizing detection of the target object and classification thereof. The neural network may be a convolutional neural network.

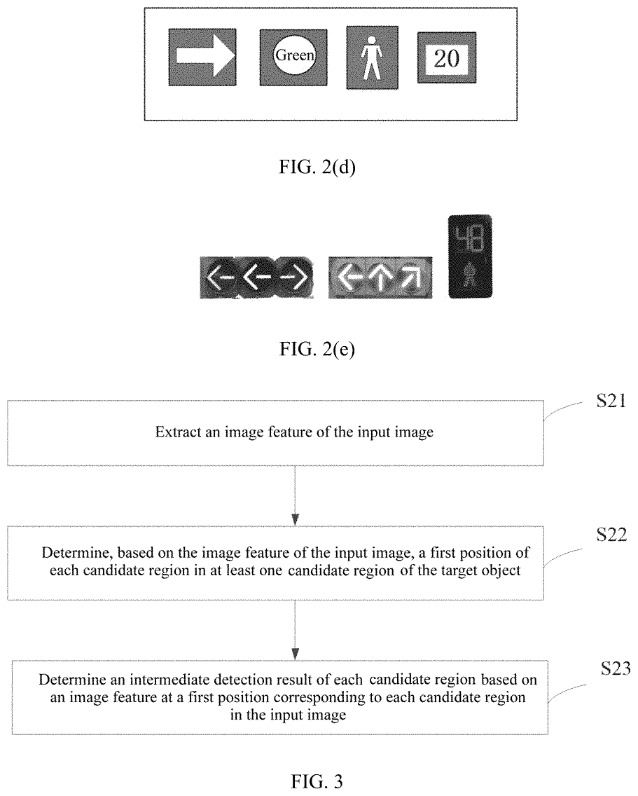

In practice applications, indicator lights included in captured input images may be in a plurality of shapes. Taking traffic indicator lights (hereinafter referred to as “traffic lights”) as an example, the traffic lights may be in various forms. In the case where the type of the traffic lights is a circular spot light, FIGS. 2(a) to 2(e) show schematic diagrams of a plurality of display states of the traffic lights, respectively. Of these, FIG. 2(a) shows different display states of the traffic lights. The shape of a traffic light base is not limited in the present disclosure.

In real life, an indicator light base may include indicator lights in multiple color states, so the indicator lights will have multiple display states accordingly. The traffic light in FIG. 2(a) is taken as an example for illustration. In the first group of traffic lights, for example, L represents a traffic light, and D represents a traffic light base. As can be appreciated from FIG. 2(a), all of the red, yellow and green lights in the first group of traffic lights are in an “OFF” state, which may be in a fault state at this time; in the second group of traffic lights, the red light is in an “ON” state; in the third group of traffic lights, the yellow light is in an “ON” state; and in the fourth group of traffic lights, the green light is in an “ON” state. In the process of recognizing a target object, it is possible to recognize whether it is an indicator light in a lighted state and recognize the color of the indicator light in a lighted state. The words “red”, “yellow”, and “green” just schematically indicate that the traffic light of the corresponding color is in an “ON” state.

FIG. 2(b) shows different arrangement modes of the traffic light base. In general, traffic lights or the other types of indicator lights can all be mounted on an indicator light base. As shown in FIG. 2(b), the arrangement mode of traffic lights on a base may include a side-to-side arrangement, an end-to-end arrangement, or a single light. Thus in the process of recognizing a target object, an arrangement mode of traffic lights may also be recognized. The foregoing is merely an exemplary description of the arrangement mode of traffic lights on a base. In other embodiments, traffic lights may also be arranged on a base in other modes.

FIG. 2(c) shows different application scenarios of traffic lights. In practice applications, indicator lights such as traffic lights may be provided at road intersections, highway intersections, sharp turn corners, safety warning locations, or travel channels. Therefore, the recognition of indicator lights can also judge and recognize application scenarios of the indicator lights. The actual application scenarios as shown in FIG. 2(c) are highway intersections marked with the “Electronic Toll Collection (ETC)” sign, sharp turn corners marked with warning signs such as “warning signal”, or other dangerous scenarios and general scenarios in this order. The above scenarios are exemplary, but are not specifically limited in the present disclosure.

FIG. 2(d) shows a plurality of types of traffic lights. Generally, shapes of traffic lights or other indicator lights are varied on demand or according to needs of scenarios. For example, FIG. 2(d) shows an arrow light containing an arrow shape, a circular spot light containing circular spots, a pedestrian light containing a pedestrian sign, or a digit light containing a digital value in this order. Also, various types of lights may also have different colors, which is not limited in the present disclosure.

FIG. 2(e) shows a schematic diagram of combinations of traffic lights in different situations. For example, there are a combination of arrow lights with different arrow directions, and a combination of a digit light and a pedestrian light; also, indication information such as colors is also shown. As described above, there are various types of indicator lights in practical applications. The present disclosure may realize recognition of indication information of indicator lights of various types.

It is precisely because of the complexity of the above situations that the embodiments of the present disclosure may firstly detect a target object in an input image to determine a detection result of the target object in the input image, and further obtain indication information of the target object based on the detection result. For example, by executing target detection on the input image, it is possible to detect the type and position of the target object in the input image, or the detection result may also include a probability of the type of the target object. In the case of obtaining the above detection result, classification detection is further executed according to the type of the detected target object to obtain the indication information of the target object, e.g., information such as color, digit, direction, and scenario of lighting.

In the embodiments of the present disclosure, types of a target to be detected (i.e., a target object) may be divided into two parts: an indicator light base and an indicator light in a lighted state, wherein the indicator light in a lighted state may include N types, for example, the type of an indicator light may include at least one of the above-mentioned digit light, pedestrian light, arrow light, and circular spot light. Therefore, when executing the detection of the target object, it is determinable that each target object included in the input image is any one of N+1 types (the base and the N types of lighted indicator lights). Alternatively, in other embodiments, other types of indicator lights may also be included, which is not specifically limited in the present disclosure.

The present disclosure may not, for example, execute detection on indicator lights in an “OFF” state. In the case that an indicator light base and an indicator light in a lighted state are not detected, it may be considered that there is no indicator light in the input image, so there is no need to execute the step of further recognizing the indication information of the target object in S30. In addition, in the case that an indicator light base is detected while an indicator light in a lighted state is not detected, it may also be deemed that there is an indicator light in an “OFF” state. In this situation, there is also no need to recognize the indication information of the target object.

S30: recognizing, based on the detection result of the target object, the target region where the target object in the input image is located to obtain indication information of the target object.

In some possible implementations, in the case where the detection result of the target object is obtained, it is possible to further detect the indication information of the target object, wherein the indication information is used to describe relevant attributes of the target object. In the field of intelligent driving, the indication information of the target object may be used to instruct an intelligent driving device to generate a control instruction based on the indication information. For example, as for a target object whose type is a base, it is possible to recognize at least one of the arrangement mode and the application scenario of the indicator lights; and as for a target object whose type is an indicator light in a lighted state, it is possible to recognize at least one information of the lighting color, the direction of the arrow, the value of the digit, etc. of the indicator light.

Based on the embodiments of the present disclosure, it is possible to first detect a base and an indicator light in a lighted state, and further classify and recognize the indication information of the target object based on the obtained detection result. That is, it is possible not to use a classifier directly to classify and recognize information such as the type, position and various indication information of the target object together, but to execute classification and recognition of indication information according to the detection results such as the type of the target object, which is beneficial to reduce the recognition complexity during the recognition of the indication information of the target object, and reduce the difficulty in recognition, while simply and conveniently realizing the detection and recognition of various types of indicator lights in different situations.

The specific process of the embodiments of the present disclosure will be illustrated below with reference to the accompanying drawings, respectively. FIG. 3 shows a flow chart of Step S20 in the method for recognizing indication information of indicator lights according to an embodiment of the present disclosure. Determining a detection result of a target object based on the input image (Step 20) may comprise:

S21: extracting an image feature of the input image;

In some possible implementations, in the case where an input image is obtained, it is possible to execute feature extraction processing on the input image to obtain the image feature of the input image. The image feature in the input image may be obtained by a feature extraction algorithm, or the image feature may be extracted by a neural network that is trained to implement feature extraction. For instance, in the embodiments of the present disclosure, a convolutional neural network may be used to obtain the image feature of the input image, and the corresponding image feature may be obtained by executing at least one layer of convolution processing on the input image. The convolutional neural network may include at least one of a Visual Geometry Group (VGG) network, a Residual Network, and Pyramid Feature Network, but they are not specifically limited in the present disclosure. The image feature may also be obtained in other manners.

S22: determining, based on the image feature of the input image, a first position of each candidate region in at least one candidate region of the target object;

In some possible implementations, it is possible to detect a position region where the target object is located in the input image based on the image feature of the input image, namely, to obtain a first position of the candidate region of each target object. It is possible to obtain at least one candidate region for each target object, and accordingly a first position of each candidate region can be obtained. The first position in the embodiments of the present disclosure may be denoted by the coordinates of the diagonal vertex position of the candidate region, which is not specifically limited in the present disclosure.

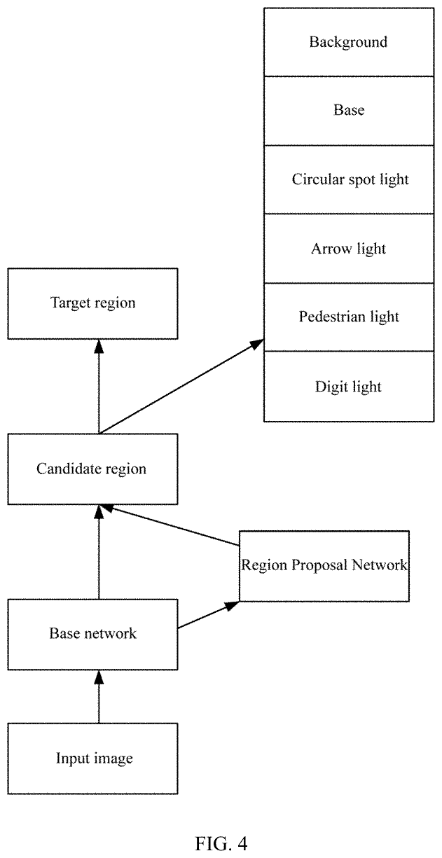

FIG. 4 shows a schematic diagram of executing target detection according to an embodiment of the present disclosure. A target detection network used to execute target detection may include a base network module, a region proposal network (RPN) module, and a classification module. Of these, the base network module is configured to execute feature extraction processing of an input image to obtain an image feature of the input image. The region proposal network module is configured to detect the candidate region (Region of Interest, ROI) of the target object in the input image based on the image feature of the input image. The classification module is configured to determine a type of the target object in the candidate region based on the image feature of the candidate region, to obtain a detection result of the target object in the target region (Box) in the input image. The detection result of the target object includes, for example, the type of the target object and the position of the target region. The type of the target object is, for example, any one of a base, an indicator light in a lighted state (such as a circular spot light, an arrow light, a pedestrian light, or a digit light), and background. Of these, the background may be interpreted as an image region except for the regions where the base and the indicator light in a lighted state are located in the input image.

In some possible implementations, the RPN may obtain at least one ROI for each target object in the input image, from which the ROI with the highest accuracy may be picked out by subsequent post-processing.

S23: determining an intermediate detection result of each candidate region based on an image feature at a first position corresponding to each candidate region in the input image, the intermediate detection result including a predicted type of the target object and the prediction probability that the target object is the predicted type; the predicted type being any one of an indicator light base and N types of indicator lights in a lighted state, N being a positive integer;

In the case where at least one candidate region (such as a first candidate region or a second candidate region) for each target object is obtained, it is possible to further classify and recognize type information of the target object in the candidate region, i.e., to obtain a predicted type of the target object in the candidate region and a prediction probability for the predicted type. The predicted type may be one of the above N+1 types, for example, it may be any one of a base, a circular spot light, an arrow light, a pedestrian light, and a digit light. In other words, it is possible to predict whether the type of the target object in the candidate region is a base or one of the N types of indicator lights in a lighted state.

Step S23 may comprise: classifying, for each candidate region, the target object in the candidate region based on the image feature at the first position corresponding to the candidate region, to obtain the prediction probability that the target object is each of the at least one preset type, wherein the preset type includes at least one of an indicator light base and N types of indicator lights in a lighted state, N being a positive integer; and taking the preset type with the highest prediction probability in the at least one preset type as the predicted type of the target object in the candidate region, and obtaining a prediction probability of the predicted type.

In some possible implementations, in the case where at least one candidate region for each target object is obtained, the image feature corresponding to the first position among the image features of the input image may be obtained according to the first position of the candidate region, and the obtained image feature is determined as an image feature of the candidate region. Further, it is possible to predict, according to the image feature of each candidate region, the prediction probability that the target object in the candidate region is each preset type.

For each candidate region, classification and recognition may be executed on the image feature in the candidate region, and accordingly, a prediction probability of each candidate region for each preset type may be obtained, wherein the preset type is the above N+1 types, such as the base and N types of indicator lights. Alternatively, in other embodiments, the preset type may also be N+2 types, which, compared with the N+1 types, further include a background type, but the present disclosure does not specifically limit thereto.

In the case where the prediction probability that a target object in a candidate region is each of the preset types is obtained, the preset type with the highest prediction probability may be determined as the predicted type of the target object in the candidate region, and accordingly, the highest prediction probability is the prediction probability of the corresponding predicted type.

In some possible implementations, before executing type classification detection on the target object of the candidate region, image features of each candidate region may be pooled, such that the image features of each candidate region have the same scale. For example, for each ROI, the size of the image feature may be zoomed to 7*7, which is not specifically limited in the present disclosure. After pooling, the pooled image features may be classified to obtain an intermediate detection result corresponding to each candidate box for each target object.

In some possible implementations, classification processing of the image feature of each candidate region in step S23 may be realized by one classifier or by a plurality of classifiers. For example, one classifier is utilized to obtain a prediction probability of a candidate region for each preset type, or N+1 or N+2 classifiers may be utilized to detect prediction probabilities of a candidate region for all types, respectively. There is a one-to-one correspondence between the N+1 or N+2 classifiers and the preset types, that is, each classifier may be used to obtain a prediction result of the corresponding preset type.

In some possible implementations, when executing classification processing on the candidate region, the image feature (or the pooled image feature) of the candidate region may also be input, via a convolutional layer, to a first convolutional layer and subjected to convolution processing to obtain a first feature map with a dimension of a×b×c wherein b and c represent the length and width of the first feature map respectively, a represents the number of channels in the first feature map, and the numerical value of a is the total number of preset types (such as N+1). Thereafter, the first feature map is subjected to global pooling to obtain a second feature map corresponding to the first feature map, and the second feature map has a dimension of a×d. The second feature map is input to the softmax function, and a third feature map with a dimension of a×d may also be obtained, wherein d is an integer equal to or greater than 1. In an example, d represents the number of columns, e.g., 1, of the third feature map, and accordingly the element obtained in the third feature map represents the prediction probability that the target object in the candidate region is each preset type. The numerical value corresponding to each element may be a probability value of the prediction probability, and the order of the probability value corresponds to the set order of the preset type. Alternatively, each element in the third feature map may be made up of a label of the preset type and the corresponding prediction probability, so as to easily determine the correspondence between the preset type and the prediction probability.

In another example, d may also be another integer value greater than 1, and the prediction probability corresponding to the preset type may be obtained according to the elements of the first preset number of columns in the third feature map. The first preset number of columns may be a predetermined value, e.g., 1, which is not specifically limited in the present disclosure.

With the configuration above, it is possible to obtain an intermediate detection result of each candidate region of each target object, and further to obtain a detection result of each target object based on the intermediate detection result.

S24: determining a detection result of the target object based on the intermediate detection result of each candidate region in at least one candidate region and the first position of each candidate region.

As described in the embodiment above, it is possible to obtain intermediate detection results (such as a first position of the candidate region, and a predicted type and a prediction probability of the target object in the candidate region) corresponding to all candidate regions for each target object. Furthermore, it is possible to determine, based on the intermediate detection result of each candidate region of the target object, a final detection result of the target object, namely, information such as a position and a type of the candidate region of the target object.

It should be noted here that in the embodiments of the present disclosure, the first position of the candidate region of each target object may be taken as the position of the candidate region, or the first position may be optimized, to obtain a more accurate first position. In the embodiments of the present disclosure, it is also possible to obtain, via the image feature of each candidate region, a position deviation of the corresponding candidate region, and adjust the first position of the candidate region according to the position deviation. An image feature of the candidate region of each target object may be input to a second convolutional layer to obtain a fourth feature map with a dimension of e×b×c, wherein b and c represent the length and width of the fourth feature map and the third feature map, respectively, while b and c may also be the length and width of the image feature of the candidate region, and e represents the number of channels in the fourth feature map, where e may be an integer equal to or greater than 1, for example, e may be 4. Furthermore, by executing global pooling on the fourth feature map, it is possible to obtain a fifth feature map that may be a feature vector having a length of e, e.g., e=4. At this time, the elements in the fifth feature map are a position deviations corresponding to the corresponding candidate regions. Or, in other embodiments, the dimension of the fifth feature map may be e×f, wherein f is a value equal to or greater than 1, indicating the number of columns of the fifth feature map. In this instance, the position deviation of the candidate region may be obtained according to the element in a preset location area in the third feature map. The preset location area may be a predetermined location area, such as elements in rows 1-4 and column 1, which is not specifically limited in the present disclosure.

The first position of the candidate region may be expressed, for example, as the horizontal and vertical coordinate values of the vertex position of the two opposite angles, and the elements in the fifth feature map may be position offset of the horizontal and vertical coordinate values of the two vertices. After the fifth feature map is obtained, the first position of the candidate region may be adjusted in accordance with the corresponding position deviation in the fifth feature map to obtain a first position with a higher accuracy. The first convolutional layer and the second convolutional layer are two different convolutional layers.

Since at least one candidate region may be detected for each target object in the input image during the detection of the target object, the embodiments of the present disclosure may filter a target region of the target object from the at least one candidate region.

In the case where only one candidate region is detected for any target object in the input image, it can be determined whether the prediction probability of the predicted type of the target object determined based on the candidate region is greater than a probability threshold. If it is greater than the probability threshold, the candidate region may be determined as the target region of the target object, and the predicted type corresponding to the candidate region is determined as the type of the target object. If the prediction probability of the predicted type of the target object determined based on the candidate region is less than the probability threshold, the candidate region is discarded, and it is determined that the objects in the candidate region do not include any target object to be detected.

Alternatively, in the case where a plurality of candidate regions are detected for one or more target objects of the input image, it is possible to filter a target region from the plurality of candidate regions based on the intermediate detection result of each candidate region, or based on the intermediate detection result of each candidate region and the first position of each candidate region, and to take the predicted type of the target object in the target region as the type of the target object, and the first position of the target region as the position of the target region where the target object is located, so as to obtain the detection result of the target object.

The step of filtering a target region based on the intermediate detection result of the candidate region may comprise, for example: selecting the candidate region with the highest prediction probability from the plurality of candidate regions of the target object, and in the case where the highest prediction probability is greater than the probability threshold, taking a first position (or an adjusted first position) of the candidate region corresponding to the highest prediction probability as the target region of the target object, and determining the predicted type corresponding to the highest prediction probability as the type of the target object.

The step of filtering a target region of the target object based on the first position of the candidate region may comprise, for example: selecting the target region of the target object from a plurality of candidate regions by means of a non-maximum suppression (NMS) algorithm. The candidate region with the largest prediction probability (hereinafter referred to as a first candidate region) may be selected from the plurality of candidate regions of the target object in the input image. Then according to the first position of the first candidate region and first positions of the remaining candidate regions, Intersection over Unions (IOUs) between the remaining candidate regions and the first candidate region are determined, respectively. If the IOU between any one of the remaining candidate regions and the first candidate region is greater than an area threshold, the any one candidate region would be discarded. If after comparison of the IOUs, all of the remaining candidate regions are discarded, the first candidate region would be the target region of the target object, and in the meantime, the predicted type of the target object obtained based on the first candidate region may be the type of the target object. If the IOU value between at least one second candidate region in the remaining candidate regions and the first candidate region is less than the area threshold, the candidate region with the highest prediction probability in the second candidate region may be retaken as a new first candidate region. Afterwards, IOUs between the remaining candidate regions in the second candidate regions and the new first candidate region are obtained, and the second candidate regions whose IOU with the first candidate region is greater than the area threshold are also discarded until there is no candidate region whose IOU with the first candidate region (or the new candidate region) is greater than the area threshold. Each first candidate region obtained in the above manner may be determined as the target region of each target object.

Alternatively, in other possible embodiments, it is also possible to filter, based on the probability threshold, a candidate region with a prediction probability greater than the probability threshold from the candidate regions of each target object, and then to obtain the target region of each target object by the above-mentioned NMS algorithm, while obtaining the predicted type for the target object in the target region, namely, determining the detection result of the target object.

It should be noted here that the above-mentioned process of determining the detection result based on the first position may also be implemented by determining the detection result of the target object based on the adjusted first position. Their specific principles are the same, and will not be repeated here.

Based on the above embodiments, it is possible to obtain a detection result of a target object existing in an input image, that is, it is possible to easily determine the type of the target object and the corresponding position. The aforementioned target detection enables it possible to obtain a detection box (a candidate region) for each target object (such as an indicator light in a lighted state or an indicator light base). For example, as for an indicator light in a lighted state, the detection result may include the location of the indicator light in a lighted state in the input image and the type of the indicator light, e.g., the detection result may be expressed as (x1,y1,x2,y2,label1,score1), wherein (x1,y1), (x2,y2) represent position coordinates (coordinates of the point of two opposite angles) of the target region of the indicator light in a lighted state, label1 represents a type label (one of 1 to N+1, e.g., 2, which may indicate a digit light) of the indicator light in a lighted state, and score1 represents confidence (i.e., a prediction probability) of the detection result.

As for an indicator light base, the detection result is expressed as (x3,y3,x4,y4,label2,score2), wherein (x3,y3), (x4,y4) represent position coordinates (coordinates of the point of two opposite angles) of the target region of the base, label2 represents a type label (one of 1 to N, e.g., 1) of the base, and score2 represents confidence of the detection result. The label of the base may be 1, and the remaining N labels may be N types of the indicator lights in a lighted state. In some possible implementations, it is also possible to label N+2, indicating a target region of the background, which is not specifically limited in the present disclosure.

In view of the above, it is simple and convenient to obtain the detection result of the target object. Meanwhile, since the detection result already includes the type information of the indicator light or the base, the classification pressure of classifiers may be reduced later.

In some possible implementations, in the case where the detection result of the target object in the input image is obtained, it is possible to further determine, based on the detection result, whether the indicator light is malfunctioning, or collect information such as the environment where the input image is captured. If the type of the detected target object in the result of the target object of the input image includes only an indicator light base, but without any type of an indicator light in a lighted state, the indicator light may be determined to be in a fault state. For example, among traffic signal lights, if none of the traffic lights is detected to be in a lighted state, the traffic light may be determined to be a fault light, and then, a fault alarming operation may be executed based on information such as the capturing time and location relating to the input image. For instance, fault information is sent to the server or other management apparatus, and the fault information may include the fault condition that the indicator light is not lighted, and the location information of the fault light (determined based on the aforesaid capturing location).

Alternatively, in some embodiments, if the detection result of the target object detected for the input image includes only an indicator light in a lighted state, but without the base corresponding to the indicator light in a lighted state, the input image may be determined to be captured in a dark environment or in a dark state, wherein the dark state or dark environment refers to an environment where the light brightness is less than the preset brightness. The preset brightness may be set according to different locations or different weather conditions, which is not specifically limited in the present disclosure.

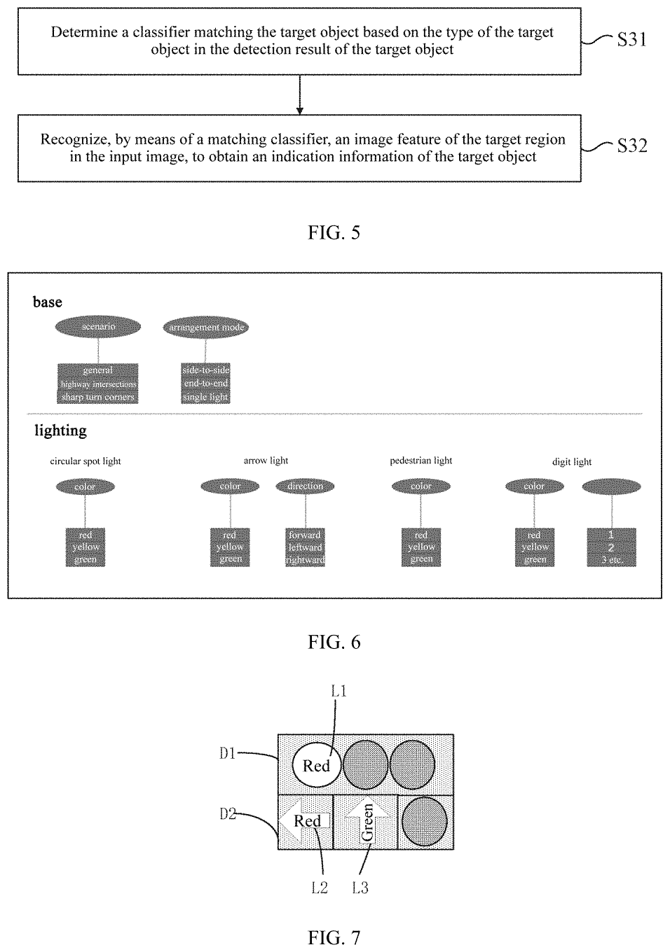

FIG. 5 shows a flow chart of Step S30 in the method for recognizing indication information of indicator lights according to an embodiment of the present disclosure. Recognizing, based on the detection result of the target object, the target region where the target object in the input image is located, to obtain indication information of the target object (S30) may comprise:

S31: determining a classifier matching the target object based on the type of the target object in the detection result of the target object; and

S32: recognizing, by means of a matching classifier, an image feature of the target region in the input image to obtain indication information of the target object.

The classifier matching the target object includes, for example, at least one kind of classifier, each of which may correspond to one or more types of target objects.

In some possible implementations, after the detection result of the target object in the input image is obtained, the classification detection of the indication information may be executed, such as the classification and recognition of at least one of the scenario information of the base, the arrangement mode of the indicator lights, and the color, description and indication direction of the indicator lights. In the embodiments of the present disclosure, different classifiers may be used to execute classification and recognition of different indication information, therefore a classifier executing classification and recognition may be determined first.

FIG. 6 shows a schematic diagram of classification detection of different target objects according to an embodiment of the present disclosure.

In some possible implementations, in the case that the recognized type of the target object is an indicator light base, it is possible to further execute classification and recognition of the indication information on the target object of the base type to obtain at least one kind of indication information of the arrangement mode of the indicator lights and the scenario where the indicator lights are located. The arrangement mode may include a side-to-side arrangement, an end-to-end arrangement, arrangement of a single indicator light, etc. The scenario may include highway intersections, sharp turn corners, general scenarios, etc. The above description of the arrangement mode and scenario are merely exemplary, and other arrangement modes or scenarios may further be included, which are not specifically limited in the present disclosure.

In some possible implementations, in the case that the recognized type of the target object is a circular spot light in a lighted state, the lighting color of the circular spot light may be classified and recognized to obtain indication information of the lighting color (such as red, green, or yellow). In the case that the recognized type of the target object is a digital indicator light in a lighted state, the digit (such as 1, 2 or 3) and the lighting color may be classified and recognized to obtain indication information of the lighting color and digit. In the case that the recognized type of the target object is an arrow indicator light in a lighted state, the indication direction (such as forward, left, and right) and the lighting color of the arrow may be classified and recognized to obtain indication information of the lighting color and indication direction. In the case that the recognized type of the target object is an indicator light with a pedestrian sign (a pedestrian light), the lighting color may be recognized to obtain indication information of the lighting color.

In other words, the embodiments of the present disclosure may execute recognition of different indication information on different types of target objects in the detection results of the target object, so as to obtain the indication information of the indicator lights more conveniently and more accurately. When executing recognition of indication information, it is possible to input the image feature corresponding to the target region where the corresponding type of target object is located to a matching classifier to obtain a classification result, namely, obtain the corresponding indication information.

For example, in a case where for the detection result of the target object in the input image, the type of at least one target object obtained is a base, the determined matching classifier includes at least one of a first classifier and a second classifier, wherein the first classifier is configured to classify and recognize an arrangement mode of indicator lights in the base, and the second classifier is configured to classify and recognize a scenario where the indicator lights are located. If the image feature corresponding to the target region of the target object of the base type is input to the first classifier, an arrangement mode of the indicator lights in the base would be obtained. If the image feature corresponding to the target region of the target object of the base type is input to the second classifier, a scenario of the indicator light would be obtained, for example, the scenario information may be obtained by means of text recognition.

In some possible implementations, in the case where the recognized type of the target object is a circular spot light or pedestrian light in a lighted state, the matching classifier is determined to include a third classifier configured to recognize a color attribute of the circular spot light or pedestrian light. At this time, the image feature of the target region corresponding to the target object of the circular spot light type or pedestrian light type may be input to the third classifier to obtain a color attribute of the indicator light.

In some possible implementations, in the case where the recognized type of the target object is an arrow light in a lighted state, the matching classifier is determined to include a fourth classifier configured to recognize a color attribute of the arrow light, and a fifth classifier configured to recognize a direction attribute of the arrow light. At this time, the image feature of the target region corresponding to the target object of the arrow light type may be input to matching fourth and fifth classifiers to recognize, by means of the fourth classifier and the fifth classifier, an image feature of the target region where the target object is located, to obtain the color attribute and the direction attribute of the arrow light, respectively.

In some possible implementations, in the case where the recognized type of the target object is a digit light in a lighted state, the matching classifier is determined to include a sixth classifier configured to recognize a color attribute of the digit light and a seventh classifier configured to recognize a numerical attribute of the digit light. At this time, the image feature of the target region corresponding to the target object of the digit light type may be input to matching sixth and seventh classifiers to recognize, based on the sixth classifier and the seventh classifier, an image feature of the target region where the target object is located, to obtain the color attribute and the numerical attribute of the digit light, respectively.

It should be noted here that the aforementioned third, fourth, and sixth classifiers that execute the classification and recognition of the color attributes may be the same classifier or different classifiers, which are not specifically limited in the present disclosure.

In addition, in some possible implementations, the aforesaid approach of acquiring an image feature of the target region may comprise: determining an image feature of a target region according to the image feature of the input image obtained by extracting a feature of the input image and according to the location position of the target region. That is to say, the feature corresponding to the location information of the target region may be obtained directly from the image feature of the input image, and taken as an image feature of the target region. Alternatively, it is also possible to acquire a subimage corresponding to the target region in the input image, and then to execute feature extraction, such as convolutional processing, on the subimage to obtain an image feature of the subimage, so as to determine the image feature of the target region. The above description is merely exemplary. In other embodiments, the image feature of the target region may also be obtained in other manners, which is not specifically limited in the present disclosure.

The above embodiments enable it possible to obtain the indication information of the target object in each target region. Different classifiers may be used to execute detection of different indication information, so that the classification result is more accurate. In the meantime, on the basis of obtaining the type of the target object, a matching classifier, rather than all classifiers, is further used for classification and recognition, which may make effective use of classifier resources and accelerate the classification speed.

In some possible implementations, the input image may include a plurality of indicator light bases, and a plurality of indicator lights in a lighted state. FIG. 7 shows a structural schematic diagram of the traffic lights in a plurality of bases. In the case where the obtained detection result includes a plurality of indicator light bases and a plurality of indicator lights in a lighted state, at this time, it is possible to match the bases with the indicator lights in a lighted state. For instance, FIG. 7 shows two indicator light bases D1 and D2, while each indicator light base may include corresponding indicator lights, and it can be determined during the recognition of indication information that there are three indicator lights in a lighted state, namely, L1, L2 and L3. By matching the indicator light bases with the indicator lights in a lighted state, it can be determined that the indicator light L1 in a lighted state matches the indicator light base D1, and at the same time, the indicator lights L2 and L3 match the base D2.

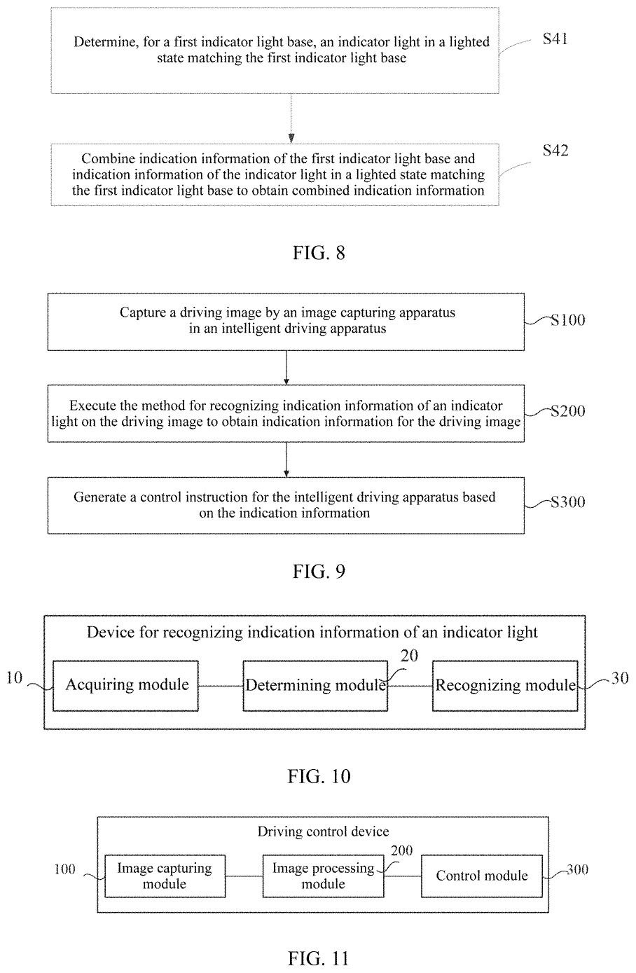

FIG. 8 shows another flow chart of a method for recognizing indication information of indicator lights according to an embodiment of the present disclosure. The method for recognizing indication information of indicator lights further comprises the process of matching an indicator light base with an indicator light in a lighted state, which specifically are:

S41: determining, for a first indicator light base, an indicator light in a lighted state matching the first indicator light base; the first indicator light base being one of the at least two indicator light bases;

The obtained detection result of the target object may include a first position of the target region for the target object of the base type and a second position where the indicator light in a lighted state is located in the target region. The embodiments of the present disclosure may determine whether the base matches the indicator light in a lighted state based on the first position of each base and the second position of each indicator light.

It is possible to determine, based on the position of the target region where the target object is located in the detection result of the target object, a first area of an intersection between the target region where the at least one indicator light in a lighted state is located and the target region where the first indicator light base is located, and to determine a second area of the target region where the at least one indicator light in a lighted state is located; and determine, in response to the case where a ratio between the first area corresponding to a first indicator light in a lighted state, and the second area of the first indicator light in a lighted state is greater than a given area threshold, that the first indicator light in a lighted state matches the first indicator light base; wherein the first indicator light in a lighted state is one of the at least one indicator light in a lighted state.

In other words, it is possible to determine, for each first indicator light base, a first area S1 of an intersection or overlap between target regions of each base and each indicator light based on the first position of the target region of the first indicator light base and the second position of the target region of each indicator light in a lighted state. If a ratio (S1/S2) between the first area S1 between an indicator light in a lighted state (a first indicator light) and an indicator light base, and the second area S2 of the target region of the indicator light in a lighted state is greater than the area threshold, the first indicator light may be determined to match the first indicator light base. If a plurality of first indicator lights are determined to match the first indicator light base, the plurality of first indicator lights may be used simultaneously as indicator lights matching the first indicator light base, or the first indicator light with the largest ratio may be determined to be an indicator light in a lighted state matching the first indicator light base. Alternatively, the preset number of indicator lights having the largest S1/S2 ratio with the first indicator light base may be determined to be indicator lights matching the first indicator light base. The preset number may be 2, but it is not specifically limited in the present disclosure. In addition, the area threshold may be a preset value, such as 0.8, but it is not specifically limited in the present disclosure.

S42: combining indication information of the first indicator light base and indication information of the indicator light in a lighted state matching the first indicator light base to obtain combined indication information.

After obtaining the indicator light in a lighted state matching the indicator light base, it is possible to combine the indication information obtained respectively for the indicator light base and the matching indicator light in a lighted state to obtain the indication information of the indicator light. As shown in FIG. 7, the indication information of the indicator light base D1 and that of the indicator light L1 in a lighted state may be combined. The determined indication information includes the information that the scenario is a general scenario, the arrangement mode of the indicator lights is a side-to-side arrangement, and the indicator light in a lighted state is a circular spot light in red color. At the same time, the indication information of the indicator light base D2 may also be combined with that of the indicator lights L2 and L3 in a lighted state. The determined indication information includes the information that the scenario is a general scene, the arrangement mode of the indicator lights is a side-to-side arrangement, and the indicator light in a lighted state is an arrow light including a rightwards arrow light and a forward arrow light, wherein the rightwards arrow light is in red color, and the forward arrow light is in green color.

Besides, as for an indicator light base whose matching indicator light in a lighted state is unfound, the base may be determined to be in an “OFF” state. That is, the indicator light corresponding to the base may be determined to be a fault light. As for the indicator lights in a lighted state whose matching indicator light base is unfound, the indication information corresponding to the indicator light in a lighted state is output individually. This situation is often caused by the inconspicuous visual features of the base, for example, it is difficult to detect the condition of the base at night.

Additionally, in the field of intelligent driving, the obtained input image may be an image of the front or rear of the vehicle captured in real time. In the case of obtaining the indication information corresponding to the indicator light in the input image, it is also possible to further generate a control instruction for driving parameters of the driving apparatus based on the obtained indication information. The driving parameters may include driving status such as driving speed, driving direction, control mode, and stopping.

In order to render the embodiments of the present disclosure clearer, an example is given below to illustrate the process of acquiring indication information in the embodiments of the present disclosure. The algorithm model used in the embodiments of the present disclosure may include two parts, wherein one part is a target detection network configured to execute target detection as shown in FIG. 4, and the other part is a classification network configured to execute classification and recognition of indication information. Referring to FIG. 4, the target detection network may include a base network module, a region proposal network (RPN) module, and a classification module. Of these, the base network module is configured to execute feature extraction processing of an input image to obtain an image feature of the input image. The region proposal network module is configured to detect the candidate region (ROI) of the target object in the input image based on the image feature of the input image. The classification module is configured to determine a type of the target object in the candidate region based on the image feature of the candidate region, to obtain a detection result of the target object in the target region in the input image.

The target detection network is input an input image and outputs 2D detection boxes of several target objects (i.e., target regions of the target objects). Each detection box may be expressed as (x1,y1,x2,y2,label,score), wherein x1, y1, x2, y2 represent position coordinates of detection boxes, and label represents a category (the value range is from 1 to N+1, the first category represents the base, and the other categories represent various indicator lights in a lighted state).

The process of target detection may comprise: inputting an input image to a Base Network to obtain an image feature of the input image. The Region Proposal Network (RPN) is utilized to generate an candidate box, i.e. ROI (Region of interest) of the indicator light, which includes the candidate box of the base and the candidate box of the indicator light in a lighted state. Then a pooling layer may be utilized to obtain a feature map of a fixed-size candidate box. For example, for each ROI, the size of the feature map is zoomed to 7*7, then, a classification module is used to judge the category of N+2 types (adding a background category), to obtain the predicted type and the position of the candidate box of each target object in the input image. Thereafter, a final detection box of the target object (the candidate box corresponding to the target region) is obtained by performing post-processing such as NMS and threshold.

Here are explanations for rationality of classifying indicator lights in a lighted state in the detected target object into N categories in the embodiments of the present disclosure:

1. Different types of indicator lights in a lighted state have different significances, and the detection results of each type often need to be studied respectively. For instance, a pedestrian light cannot be confused with a vehicle circular spot light.

2. There is a serious imbalance in the number of samples among different types of indicators light in a lighted state. Classifying the indicator lights in a lighted state into different N categories renders it convenient to adjust model parameters, and to adjust and optimize, separately.

In the case where a detection result of each target object is obtained, indication information of the target object may be further recognized. The indication information may be classified and recognized by a matching classifier. A classification module including a plurality of classifiers may be used to execute recognition of indication information of the target object. The classification module may include a plurality types of classifiers configured to execute classification and recognition of different indication information, or may include a convolutional layer configured to extract features, which is not specifically limited in the present disclosure.

The input of the classification module may be an image feature corresponding to the target region of the detected target object, and the output is indication information corresponding to each target object of the target region.

The specific process may comprise: inputting a detection box of a target region of a target object, selecting a classifier matching the type (1 to N+1) of the target object in the detection box, and obtaining the corresponding classification result. In case of a detection box of an indicator light base, since the indicator light base may be regarded as a simple entity, all classifiers of the indicator light base are activated, for example, the classifiers configured to recognize the scenario and the arrangement mode are all activated to recognize the scenario attribute and arrangement mode attribute; in case of a detection box of an indicator light in a lighted state, it is needed to select different classifiers for different types of indicators light in a lighted state, for example, the arrow light corresponds to two classifiers for “color” and “arrow direction”, the circular spot light corresponds to a classifier for “color”, and so forth. In addition, if demands for judging other attributes are added, other classifiers may also be added, which is not specifically limited in the present disclosure.

In summary, the embodiments of the present disclosure may first perform target detection processing on an input image to obtain a detection result of a target object, wherein the detection result of the target object may include information such as the position and type of the target object, and then execute recognition of the indication information of the target object based on the detection result of the target object.

By dividing the process of detecting the target object into two steps of detecting the base and the indicator light in a lighted state, the present disclosure realizes for the first time the discrimination of the target object during the detection. When the target object is further recognized later based on the detection result of the target object, it is conducive to reducing the recognition complexity in the process of recognizing indication information of the target object and reducing the recognition difficulty, which enables it possible to simply and conveniently realize the detection and recognition of various types of indicator lights in different situations.

In addition, the embodiments of the present disclosure use only picture information without using other sensors to realize detection of indicator lights and judgment on indication information. Meanwhile, the embodiments of the present disclosure may detect different types of indicator lights, and are better applicable.

FIG. 9 shows a flow chart of a driving control method according to an embodiment of the present disclosure. The driving control method may be applied to apparatuses such as intelligent vehicles, intelligent aircrafts, and toys that can regulate driving parameters according to control instructions. The driving control method may comprise:

S100: capturing a driving image by an image capturing apparatus in an intelligent driving apparatus;

When an intelligent driving apparatus is driving, an image capturing apparatus in an intelligent driving apparatus may be set to capture a driving image, or it is possible to receive a driving image of a driving location captured by other apparatuses.

S200: executing the said method for recognizing indication information of indicator lights on the driving image to obtain indication information of the driving image;

The driving image is subjected to detection processing of indication information, i.e., implementing the said method for recognizing indication information of indicator lights according to the above embodiments, to obtain the indication information of indicator lights in the driving image.

S300: generating a control instruction for the intelligent driving apparatus based on the indication information.

It is possible to control driving parameters of the driving apparatus in real time based on the obtained indication information, that is, it is possible to generate a control instruction for controlling the intelligent driving apparatus based on the obtained indication information, wherein the control instruction may be used to control driving parameters of the intelligent driving apparatus, and the driving parameters may include at least one of driving speed, driving direction, driving mode, and driving state. As for the parameters control for the driving apparatus or the type of the control instruction, a person skilled in the art may set it according to prior technical means and demands, which is not specifically limited in the present disclosure.

Based on the embodiments of the present disclosure, it is possible to realize intelligent control of an intelligent driving apparatus. Since the acquisition process of the indication information is simple, rapid, and high in accuracy, the efficiency and accuracy of controlling an intelligent driving apparatus may be increased.

A person skilled in the art may understand that, in the foregoing method according to specific embodiments, the order of describing the steps does not means a strict order of execution that imposes any limitation on the implementation process. Rather, a specific order of execution of the steps should depend on the functions and possible inherent logics of the steps. Without departing from the logics, the different implementations provided in the present disclosure may be combined with each other.

It should be understandable that without violating the principle and the logics, the above method embodiments described in the present disclosure may be combined with one another to form a combined embodiment, which, due to limited space, will not be repeatedly described in the present disclosure.

In addition, the present disclosure further provides a device for recognizing indication information of indicator lights, a driving control device, an electronic apparatus, a computer readable storage medium, and a program, which are all capable of realizing any one of the methods for recognizing indication information of indicator lights and/or the driving control methods provided in the present disclosure. For the corresponding technical solutions and descriptions which will not be repeated, reference may be made to the corresponding descriptions of the method.

FIG. 10 shows a block diagram of a device for recognizing indication information of indicator lights according to an embodiment of the present disclosure. As shown in FIG. 10, the device for recognizing indication information of indicator lights comprises:

an acquiring module 10 configured to acquire an input image;

a determining module 20 configured to determine a detection result of a target object based on the input image, the target object including at least one of an indicator light base and an indicator light in a lighted state, and the detection result including a type of the target object and a position of the target region where the target object in the input image is located; and

a recognizing module 30 configured to recognize, based on the detection result of the target object, the target region where the target object in the input image is located, to obtain indication information of the target object.

In some possible implementations, the determining module is further configured to:

extract an image feature of the input image;

determine, based on the image feature of the input image, a first position of each candidate region in at least one candidate region of the target object;

determine an intermediate detection result of each candidate region based on an image feature at a first position corresponding to each candidate region of the input image, the intermediate detection result including a predicted type of the target object and the prediction probability that the target object is the predicted type; the predicted type being any one of an indicator light base and N types of indicator lights in a lighted state, N being a positive integer;

and

determine a detection result of the target object based on the intermediate detection result of each candidate region in at least one candidate region and the first position of each candidate region.

In some possible implementations, the determining module is further configured to classify, for each candidate region, the target object in the candidate region based on the image feature at the first position corresponding to the candidate region, to obtain the prediction probability that the target object is each of the at least one preset type, wherein the preset type includes at least one of an indicator light base and N types of indicator lights in a lighted state, N being a positive integer; and

take the preset type with the highest prediction probability in the at least one preset type as the predicted type of the target object in the candidate region, and obtain a prediction probability of the predicted type.

In some possible implementations, the determining module is further configured to, before determining a detection result of the target object based on the intermediate detection result of each candidate region in at least one candidate region and the first position of each candidate region, determine a position deviation of a first position of each candidate region based on the image feature of the input image; and

adjust the first position of each candidate region according to the position deviation corresponding to each candidate region.

In some possible implementations, the determining module further configured to filter, in the case where there are at least two candidate regions of the target object, a target region from the at least two candidate regions based on the intermediate detection result of each of the at least two candidate regions, or based on the intermediate detection result of each candidate region and the first position of each candidate region; and

take the predicted type of the target object in the target region as the type of the target object, take the first position of the target region as the position of the target region where the target object is located, to obtain a detection result of the target object.

In some possible implementations, the determining module is further configured to determine, in the case where the detection result of the target object includes only a detection result of an indicator light base, that the indicator light is in a fault state; and

determine, in the case where the detection result of the target object includes only a detection result of an indicator light in a lighted state, that the scenario state in which the input image is captured is a dark state.

In some possible implementations, the recognizing module is further configured to determine a classifier matching the target object based on the type of the target object in the detection result of the target object; and

recognize, by means of a matching classifier, an image feature of the target region in the input image to obtain indication information of the target object.

In some possible implementations, the recognizing module is further configured to determine, in the case where the type of the target object is an indicator light base, that the matching classifier includes a first classifier configured to recognize an arrangement mode of indicator lights in the indicator light base; recognize, by means of the first classifier, an image feature of the target region where the target object is located, to determine the arrangement mode of indicator lights in the indicator light base; and/or

determine that the matching classifier includes a second classifier configured to recognize a scenario where the indicator lights are located; recognize, by means of the second classifier, an image feature of the target region where the target object is located, to determine information about the scenario where the indicator lights are located.

In some possible implementations, the recognizing module is further configured to determine, in the case where the type of the target object is a circular spot light or a pedestrian light, that the matching classifier includes a third classifier configured to recognize a color attribute of the circular spot light or the pedestrian light; and

recognize, by means of the third classifier, an image feature of the target region where the target object is located, to determine the color attribute of the circular spot light or the pedestrian light.

In some possible implementations, the recognizing module is further configured to determine, in the case where the type of the target object is an arrow light, that the matching classifier includes a fourth classifier configured to recognize a color attribute of the arrow light, and a fifth classifier configured to recognize a direction attribute of the arrow light; and

recognize, by means of the fourth classifier and the fifth classifier, an image feature of the target region where the target object is located, to determine the color attribute and the direction attribute of the arrow light, respectively.

In some possible implementations, the recognizing module is further configured to determine, in the case where the type of the target object is a digit light, that the matching classifier includes a sixth classifier configured to recognize a color attribute of the digit light, and a seventh classifier configured to recognize a numerical attribute of the digit light; and

recognize, based on the sixth classifier and the seventh classifier, an image feature of the target region where the target object is located, to determine the color attribute and the numerical attribute of the digit light, respectively.

In some possible implementations, the device further comprises a matching module configured to determine, for a first indicator light base, an indicator light in a lighted state matching the first indicator light base in the case where the input image includes at least two indicator light bases; the first indicator light base being one of the at least two indicator light bases; and

combine indication information of the first indicator light base and indication information of the indicator light in a lighted state matching the first indicator light base to obtain combined indication information.

In some possible implementations, the matching module is further configured to:

determine, based on the position of the target region where the target object is located in the detection result of the target object, a first area of an intersection between the target region where the at least one indicator light in a lighted state is located and the target region where the first indicator light base is located, and a second area of the target region where the at least one indicator light in a lighted state is located; and

determine, in the case where a ratio between the first area between a first indicator light in a lighted state and the first indicator light base, and the second area of the first indicator light in a lighted state is greater than a given area threshold, that the first indicator light in a lighted state matches the first indicator light base;

wherein the first indicator light in a lighted state is one of the at least one indicator light in a lighted state.

In addition, FIG. 11 shows a block diagram of a driving control device according to an embodiment of the present disclosure. The driving control device comprises:

an image capturing module 100 disposed in an intelligent driving apparatus and configured to capture a driving image of the intelligent driving apparatus;

an image processing module 200 configured to execute the method for recognizing indication information of indicator lights according to any one of the first aspect on the driving image to obtain indication information of the driving image; and

a control module 300 configured to generate a control instruction for the intelligent driving apparatus based on the indication information.

In some embodiments, functions of or modules included in the device provided in the embodiments of the present disclosure may be configured to execute the method described in the foregoing method embodiments. For specific implementation of the functions or modules, reference may be made to descriptions of the foregoing method embodiments. For brevity, details are not described here again.

The embodiments of the present disclosure further propose a computer readable storage medium having computer program instructions stored thereon, wherein the computer program instructions, when executed by a processor, execute the method above. The computer readable storage medium may be a non-volatile computer readable storage medium or a volatile computer readable storage medium.

The embodiments of the present disclosure further propose an electronic apparatus, comprising: a processor; and a memory configured to store processor-executable instructions; wherein the processor is configured to carry out the method above.

The embodiments of the present disclosure further propose a computer program, comprising a computer readable code, wherein when the computer readable code operates in an electronic apparatus, a processor in the electronic apparatus executes instructions for implementing the method provided above.

The electronic apparatus may be provided as a terminal, a server, or an apparatus in other forms.

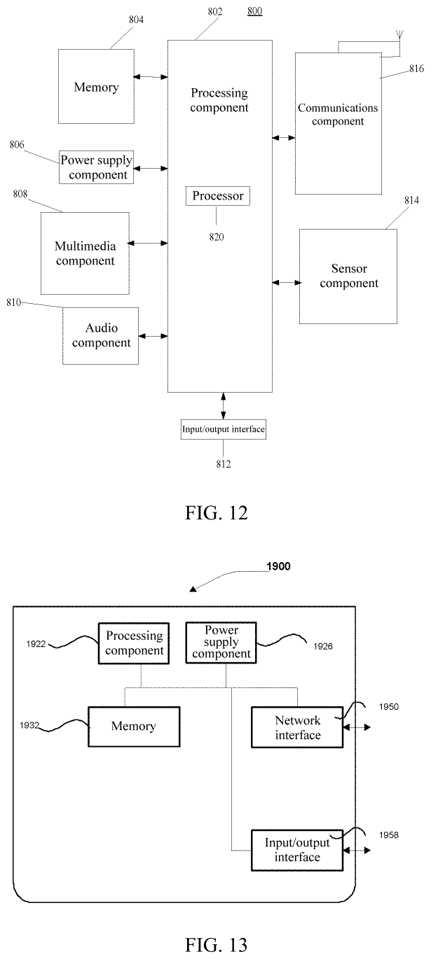

FIG. 12 shows a block diagram of an electronic apparatus according to an embodiment of the present disclosure. For example, electronic apparatus 800 may be a mobile phone, a computer, a digital broadcasting terminal, a message transmitting and receiving apparatus, a game console, a tablet apparatus, medical equipment, fitness equipment, a personal digital assistant, and other terminals.

Referring to FIG. 12, electronic apparatus 800 may include one or more of the following components: a processing component 802, a memory 804, a power component 806, a multimedia component 808, an audio component 810, an input/output (I/O) interface 812, a sensor component 814, and a communication component 816.

Processing component 802 is configured usually to control overall operations of electronic apparatus 800, such as the operations associated with display, telephone calls, data communications, camera operations, and recording operations. Processing component 802 can include one or more processors 820 configured to execute instructions to perform all or part of the steps included in the above-described methods. In addition, processing component 802 may include one or more modules configured to facilitate the interaction between the processing component 802 and other components. For example, processing component 802 may include a multimedia module configured to facilitate the interaction between multimedia component 808 and processing component 802.

Memory 804 is configured to store various types of data to support the operation of electronic apparatus 800. Examples of such data include instructions for any applications or methods operated on electronic apparatus 800, contact data, phonebook data, messages, pictures, video, etc. Memory 804 may be implemented using any type of volatile or non-volatile memory apparatus, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic disk, or an optical disk.

Power component 806 is configured to provide power to various components of electronic apparatus 800. Power component 806 may include a power management system, one or more power sources, and any other components associated with the generation, management, and distribution of power in electronic apparatus 800.

Multimedia component 808 includes a screen providing an output interface between electronic apparatus 800 and the user. In some embodiments, the screen may include a liquid crystal display (LCD) and a touch panel (TP). If the screen includes the touch panel, the screen may be implemented as a touch screen to receive input signals from the user. The touch panel may include one or more touch sensors configured to sense touches, swipes, and gestures on the touch panel. The touch sensors may sense not only a boundary of a touch or swipe action, but also a period of time and a pressure associated with the touch or swipe action. In some embodiments, multimedia component 808 includes a front camera and/or a rear camera. The front camera and/or the rear camera may receive an external multimedia datum while electronic apparatus 800 is in an operation mode, such as a photographing mode or a video mode. Each of the front camera and the rear camera may be a fixed optical lens system or may have focus and/or optical zoom capabilities.

Audio component 810 is configured to output and/or input audio signals. For example, audio component 810 includes a microphone (MIC) configured to receive an external audio signal when electronic apparatus 800 is in an operation mode, such as a call mode, a recording mode, and a voice recognition mode. The received audio signal may be further stored in memory 804 or transmitted via communication component 816. In some embodiments, audio component 810 further includes a speaker configured to output audio signals.

I/O interface 812 is configured to provide an interface between processing component 802 and peripheral interface modules, such as a keyboard, a click wheel, buttons, and the like. The buttons may include, but are not limited to, a home button, a volume button, a starting button, and a locking button.

Sensor component 814 includes one or more sensors configured to provide status assessments of various aspects of electronic apparatus 800. For example, sensor component 814 may detect at least one of an on/off status of electronic apparatus 800, relative positioning of components, e.g., the components being the display and the keypad of the electronic apparatus 800. The sensor component 814 may further detect a change of position of the electronic apparatus 800 or one component of the electronic apparatus 800, presence or absence of contact between the user and the electronic apparatus 800, location or acceleration/deceleration of the electronic apparatus 800, and a change of temperature of the electronic apparatus 800. Sensor component 814 may include a proximity sensor configured to detect the presence of nearby objects without any physical contact. Sensor component 814 may also include a light sensor, such as a CMOS or CCD image sensor, for use in imaging applications. In some embodiments, sensor component 814 may also include an accelerometer sensor, a gyroscope sensor, a magnetic sensor, a pressure sensor, or a temperature sensor.

Communication component 816 is configured to facilitate wired or wireless communication between electronic apparatus 800 and other apparatus. Electronic apparatus 800 can access a wireless network based on a communication standard, such as WiFi, 2G, or 3G, or a combination thereof. In an exemplary embodiment, communication component 816 receives a broadcast signal from an external broadcast management system or broadcast associated information via a broadcast channel. In an exemplary embodiment, communication component 816 may include a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, or any other suitable technologies.

In exemplary embodiments, the electronic apparatus 800 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above-described methods.

In exemplary embodiments, there is also provided a non-volatile computer readable storage medium or a volatile computer readable storage medium such as memory 804 including computer program instructions, which are executable by processor 820 of electronic apparatus 800, for completing the above-described methods.

FIG. 13 shows another block diagram showing an electronic apparatus according to an embodiment of the present disclosure. For example, the electronic apparatus 1900 may be provided as a server. Referring to FIG. 13, the electronic apparatus 1900 includes a processing component 1922, which further includes one or more processors, and a memory resource represented by a memory 1932 configured to store instructions such as application programs executable for the processing component 1922. The application programs stored in the memory 1932 may include one or more than one module of which each corresponds to a set of instructions. In addition, the processing component 1922 is configured to execute the instructions to execute the above-mentioned methods.

The electronic apparatus 1900 may further include a power component 1926 configured to execute power management of the electronic apparatus 1900, a wired or wireless network interface 1950 configured to connect the electronic apparatus 1900 to a network, and an Input/Output (I/O) interface 1958. The electronic apparatus 1900 may be operated on the basis of an operating system stored in the memory 1932, such as Windows Server™, Mac OS X™, Unix™, Linux™ or FreeBSD™.

In exemplary embodiments, there is also provided a non-volatile computer readable storage medium or a volatile computer readable storage medium, for example, memory 1932 including computer program instructions, which are executable by processing component 1922 of the electronic apparatus 1900, to complete the above-described methods.

The present disclosure may be a system, a method, and/or a computer program product. The computer program product may include a computer readable storage medium having computer readable program instructions thereon for causing a processor to carry out aspects of the present disclosure.

The computer readable storage medium can be a tangible apparatus that can retain and store instructions for use by an instruction execution apparatus. The computer readable storage medium may be, for example, but is not limited to, an electronic storage apparatus, a magnetic storage apparatus, an optical storage apparatus, an electromagnetic storage apparatus, a semiconductor storage apparatus, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing apparatuses from a computer readable storage medium or to an external computer or external storage apparatus via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing apparatus receives computer readable program instructions from the network and forwards the computer readable program instructions for storage in a computer readable storage medium within the respective computing/processing apparatus.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowcharts and/or block diagrams of methods, device (systems), and computer program products according to embodiments of the present disclosure. It will be appreciated that each block of the flowcharts and/or block diagrams, and combinations of blocks in the flowcharts and/or block diagrams, can be implemented by computer readable program instructions.

These computer readable program instructions may be provided to a processor of a general purpose computer, special purpose computer, or other programmable data processing devices to produce a machine, such that the instructions, which execute via the processor of the computer or other programmable data processing devices, create means for implementing the functions/acts specified in the flowchart and/or block diagram block or blocks. These computer readable program instructions may also be stored in a computer readable storage medium that can direct a computer, a programmable data processing device, and/or other apparatuses to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing devices, or other device to cause a series of operational steps to be performed on the computer, other programmable data processing devices or other apparatus to produce a computer implemented process, such that the instructions which execute on the computer, other programmable data processing devices, or other apparatus implement the functions/acts specified in the flowchart and/or block diagram block or blocks.

The flowcharts and block diagrams in the drawings illustrate the architecture, functionality, and operation of possible implementations of systems, methods and computer program products according to various embodiments of the present disclosure. In this regard, each block in the flowcharts or block diagrams may represent a module, program segment, or portion of instruction, which comprises one or more executable instructions for implementing the specified logical function(s). In some alternative implementations, the functions noted in the block may occur out of the order noted in the drawings. For example, two blocks shown in succession may, in fact, be executed substantially concurrently, or the blocks may sometimes be executed in the reverse order, depending upon the functionality involved. It will also be noted that each block of the block diagrams and/or flowcharts, and combinations of blocks in the block diagrams and/or flowcharts, can be implemented by special purpose hardware-based systems that perform the specified functions or acts, or combinations of special purpose hardware and computer instructions.

Although the embodiments of the present disclosure have been described above, the foregoing descriptions are exemplary but not exhaustive, and the disclosed embodiments are not limiting. For a person skilled in the art, a number of modifications and variations are obvious without departing from the scope and spirit of the described embodiments. The terms used herein are intended to provide the best explanations on the principles of the embodiments, practical applications, or technical improvements to the technologies in the market, or to make the embodiments described herein understandable to other persons skilled in the art.

What is claimed is:

1. A method for recognizing indication information of an indicator light, comprising:
acquiring an input image;
determining a detection result of a target object based on the input image, the target object including at least one of an indicator light base and an indicator light in a lighted state, and the detection result including a type of the target object and a position of a target region where the target object is located in the input image; and
recognizing, based on the detection result of the target object, the target region where the target object is located in the input image to obtain the indication information of the target object.

2. The method according to claim 1, wherein determining the detection result of the target object based on the input image comprises:
extracting an image feature of the input image;
determining, based on the image feature of the input image, a first position of each candidate region in at least one candidate region of the target object;
determining an intermediate detection result of each candidate region based on an image feature at a first position corresponding to each candidate region in the input image, the intermediate detection result including a predicted type of the target object and a prediction probability that the target object is the predicted type, the predicted type being any one of an indicator light base and N types of indicator lights in a lighted state, N being a positive integer; and
determining the detection result of the target object based on the intermediate detection result of each candidate region in the at least one candidate region and the first position of each candidate region.

3. The method according to claim 2, wherein determining the intermediate detection result of each candidate region based on the image feature at the first position corresponding to each candidate region in the input image comprises:
classifying, for each candidate region, the target object in the candidate region based on the image feature at the first position corresponding to the candidate region, and obtaining the prediction probability that the target object is each of at least one preset type, wherein the preset type includes at least one of an indicator light base and N types of indicator lights in a lighted state, N being a positive integer; and
taking a preset type with the highest prediction probability in the at least one preset type as the predicted type of the target object in the candidate region, and obtaining a prediction probability of the predicted type.

4. The method according to claim 2, wherein before determining the detection result of the target object based on the intermediate detection result of each candidate region in the at least one candidate region and the first position of each candidate region, the method further comprises:
determining a position deviation of the first position of each candidate region based on the image feature of the input image; and
adjusting the first position of each candidate region according to the position deviation corresponding to each candidate region.

5. The method according to claim 2, wherein determining the detection result of the target object based on the intermediate detection result of each candidate region in the at least one candidate region and the first position of each candidate region comprises:
filtering, in response to the case where there are at least two candidate regions of the target object, the target region from the at least two candidate regions, based on the intermediate detection result of each candidate region in the at least two candidate regions, or based on the intermediate detection result of each candidate region and the first position of each candidate region; and
taking the predicted type of the target object in the target region as the type of the target object, and taking the first position of the target region as the position of the target region where the target object is located, to obtain the detection result of the target object.

6. The method according to claim 1, wherein after determining the detection result of the target object based on the input image, the method further comprises at least one of:
determining, in response to the case where the detection result of the target object includes only a detection result corresponding to an indicator light base, that the indicator light is in a fault state; and
determining, in response to the case where the detection result of the target object includes only a detection result corresponding to an indicator light in a lighted state, that the scenario state in which the input image is captured is a dark state.

7. The method according to claim 1, wherein recognizing, based on the detection result of the target object, the target region where the target object is located in the input image to obtain the indication information of the target object comprises:
determining a classifier matching the target object based on the type of the target object in the detection result of the target object; and
recognizing, by means of a matching classifier, the image feature of the target region in the input image to obtain the indication information of the target object.

8. The method according to claim 7, wherein recognizing, based on the detection result of the target object, the target region where the target object is located in the input image to obtain the indication information of the target object comprises:
determining, in response to the case where the type of the target object is an indicator light base, that the matching classifier includes a first classifier configured to recognize an arrangement mode of indicator lights in the indicator light base, and recognizing, by means of the first classifier, the image feature of the target region where the target object is located, to determine the arrangement mode of the indicator lights in the indicator light base; and/or
determining that the matching classifier includes a second classifier configured to recognize a scenario where the indicator light is located, and recognizing, by means of the second classifier, the image feature of the target region where the target object is located, to determine information about the scenario where the indicator light is located.

9. The method according to claim 7, wherein recognizing, based on the detection result of the target object, the target region where the target object is located in the input image to obtain the indication information of the target object comprises:
determining, in response to the case where the type of the target object is a circular spot light or a pedestrian light, that the matching classifier includes a third classifier configured to recognize a color attribute of the circular spot light or the pedestrian light; and
recognizing, by means of the third classifier, the image feature of the target region where the target object is located to determine the color attribute of the circular spot light or the pedestrian light.

10. The method according to claim 7, wherein recognizing, based on the detection result of the target object, the target region where the target object is located in the input image to obtain the indication information of the target object comprises:
determining, in response to the case where the type of the target object is an arrow light, that the matching classifier includes a fourth classifier configured to recognize a color attribute of the arrow light and a fifth classifier configured to recognize a direction attribute of the arrow light; and
recognizing, by means of the fourth classifier and the fifth classifier, the image feature of the target region where the target object is located, to determine the color attribute and the direction attribute of the arrow light respectively.

11. The method according to claim 7, wherein recognizing, based on the detection result of the target object, the target region where the target object is located in the input image to obtain the indication information of the target object comprises:
determining, in response to the case where the type of the target object is a digit light, that the matching classifier includes a sixth classifier configured to recognize a color attribute of the digit light and a seventh classifier configured to recognize a numerical attribute of the digit light; and
recognizing, by means of the sixth classifier and the seventh classifier, the image feature of the target region where the target object is located, to determine the color attribute and the numerical attribute of the digit light respectively.

12. The method according to claim 1, wherein in response to the case where the input image includes at least two indicator light bases, the method further comprises:
determining, for a first indicator light base, an indicator light in a lighted state matching the first indicator light base, the first indicator light base being one of the at least two indicator light bases; and
combining indication information of the first indicator light base and indication information of the indicator light in a lighted state matching the first indicator light base to obtain combined indication information.

13. The method according to claim 12, wherein determining the indicator light in a lighted state matching the first indicator light base comprises:
determining, based on the position of the target region where the target object is located in the detection result of the target object, a first area of an intersection between the target region where at least one indicator light in a lighted state is located and the target region where the first indicator light base is located, and a second area of the target region where the at least one indicator light in a lighted state is located; and
determining, in response to the case where a ratio between the first area between a first indicator light in a lighted state and the first indicator light base and the second area of the first indicator light in a lighted state is greater than a given area threshold, that the first indicator light in a lighted state matches the first indicator light base,
wherein the first indicator light in a lighted state is one of the at least one indicator light in a lighted state.

14. The method according to claim 1, wherein the input image is a driving image captured by an image capturing apparatus in an intelligent driving apparatus, the obtained indication information is an indication information for the driving image;
the method further comprises generating a control instruction for the intelligent driving apparatus based on the indication information.

15. An electronic apparatus, comprising:
a processor; and
a memory configured to store processor-executable instructions;
wherein the processor is configured to invoke instructions stored in the memory, so as to:
acquire an input image;
determine a detection result of a target object based on the input image, the target object including at least one of an indicator light base and an indicator light in a lighted state, and the detection result including a type of the target object and a position of a target region where the target object is located in the input image; and
recognize, based on the detection result of the target object, the target region where the target object is located in the input image to obtain the indication information of the target object.

16. The method according to claim 15, wherein determining the detection result of the target object based on the input image comprises:
extracting an image feature of the input image;
determining, based on the image feature of the input image, a first position of each candidate region in at least one candidate region of the target object;
determining an intermediate detection result of each candidate region based on an image feature at a first position corresponding to each candidate region in the input image, the intermediate detection result including a predicted type of the target object and a prediction probability that the target object is the predicted type, the predicted type being any one of an indicator light base and N types of indicator lights in a lighted state, N being a positive integer; and
determining the detection result of the target object based on the intermediate detection result of each candidate region in the at least one candidate region and the first position of each candidate region.

17. The method according to claim 16, wherein determining the intermediate detection result of each candidate region based on the image feature at the first position corresponding to each candidate region in the input image comprises:
classifying, for each candidate region, the target object in the candidate region based on the image feature at the first position corresponding to the candidate region, and obtaining the prediction probability that the target object is each of at least one preset type, wherein the preset type includes at least one of an indicator light base and N types of indicator lights in a lighted state, N being a positive integer; and
taking a preset type with the highest prediction probability in the at least one preset type as the predicted type of the target object in the candidate region, and obtaining a prediction probability of the predicted type.

18. The method according to claim 16, wherein before determining the detection result of the target object based on the intermediate detection result of each candidate region in the at least one candidate region and the first position of each candidate region, the processor is further configured to:
determine a position deviation of the first position of each candidate region based on the image feature of the input image; and
adjust the first position of each candidate region according to the position deviation corresponding to each candidate region.

19. The method according to claim 16, wherein determining the detection result of the target object based on the intermediate detection result of each candidate region in the at least one candidate region and the first position of each candidate region comprises:
filtering, in response to the case where there are at least two candidate regions of the target object, the target region from the at least two candidate regions, based on the intermediate detection result of each candidate region in the at least two candidate regions, or based on the intermediate detection result of each candidate region and the first position of each candidate region; and
taking the predicted type of the target object in the target region as the type of the target object, and taking the first position of the target region as the position of the target region where the target object is located, to obtain the detection result of the target object.

20. A non-transitory computer readable storage medium having computer program instructions stored thereon, wherein when the computer program instructions are executed by a processor, the processor is caused to perform the operations of:
acquiring an input image;
determining a detection result of a target object based on the input image, the target object including at least one of an indicator light base and an indicator light in a lighted state, and the detection result including a type of the target object and a position of a target region where the target object is located in the input image; and
recognizing, based on the detection result of the target object, the target region where the target object is located in the input image to obtain the indication information of the target object.
